(19) United States
(12) Patent Application Publication
(10) Pub. No.: US 2018/0269780 A1
(43) Pub. Date: Sep. 20, 2018

(54) CONTROLLER APPLIED TO A POWER CONVERTER AND OPERATION METHOD THEREOF

(71) Applicant: Leadtrend Technology Corp., Hsinchu County (TW)

(72) Inventors: Ming-Chang Tsou, Hsinchu County (TW); Yu-Bin Wang, Hsinchu County (TW)

(21) Appl. No.: 15/921,669

(22) Filed: Mar. 15, 2018

(30) Foreign Application Priority Data
Mar. 17, 2017 (TW) 106108987

(51) Int. Cl. H02M 1/42; H02M 1/08; H02M 3/156

(52) U.S. Cl. CPC H02M 1/4225; H02M 3/156; H02M 1/083

(57) ABSTRACT

A controller applied to a power converter includes a control signal generation circuit and a gate control signal generation circuit. The control signal generation circuit is used for generating a control signal when an input voltage inputted to the power converter is greater than a predetermined voltage. The gate control signal generation circuit is coupled to the control signal generation circuit. When the gate control signal generation circuit receives the control signal, the gate control signal generation circuit generates a gate control signal corresponding to a continuous conduction mode of the power converter to a power switch of the power converter, and the power switch is turned on and turned off according to the gate control signal.

### BACKGROUND OF THE INVENTION

### 1. Field of the Invention

The present invention relates to a controller applied to a power converter and an operation method thereof, and particularly to a controller and an operation method thereof that can utilize a turning-on time of a power switch of the converter to determine whether to switch an operation mode of the power converter to increase efficiency of power factor correction of the power converter.

### 2. Description of the Prior Art

A power factor correction (PFC) boost power converter provided by the prior art only can operate in a discontinuous conduction mode (DCM), or in a continuous conduction mode (CCM), or in an interleaved mode. However, because an input voltage inputted in the boost power converter is changed with a load coupled to the boost power converter, power factor correction efficiency of the boost power converter only operating in one mode (e.g. the discontinuous conduction mode, the continuous conduction mode, or the interleaved mode) may become poorer because of variation of the input voltage inputted in the boost power converter. Therefore, the power factor correction boost power converter provided by the prior art has a lot of room for improvement.

### SUMMARY OF THE INVENTION

An embodiment of the present invention provides a controller applied to a power converter. The controller includes a control signal generation circuit and a gate control signal generation circuit. The control signal generation circuit is used for generating a control signal when an input voltage inputted to the power converter is greater than a predetermined voltage. The gate control signal generation circuit is coupled to the control signal generation circuit, wherein when the gate control signal generation circuit receives the control signal, the gate control signal generation circuit generates a gate control signal corresponding to a continuous conduction mode of the power converter to a power switch of the power converter, wherein the power switch is turned on and turned off according to the gate control signal.

Another embodiment of the present invention provides a controller applied to a power converter. The controller includes a control signal generation circuit, a ramp voltage generation circuit, and a gate control signal generation circuit. The control signal generation circuit is used for generating a control signal when an input voltage inputted to the power converter is greater than a predetermined voltage. The ramp voltage generation circuit is coupled to the control signal generation circuit, wherein when the ramp voltage generation circuit receives the control signal, the ramp voltage generation circuit utilizes a fixed current, a variable current, and a capacitor to generate a ramp voltage, and when the ramp voltage generation circuit does not receive the control signal, the ramp voltage generation circuit utilizes the fixed current and the capacitor to generate the ramp voltage. The gate control signal generation circuit is coupled to the ramp voltage generation circuit, wherein the gate control signal generation circuit determines a turning-on time of agate control signal according to the ramp voltage and a compensation voltage corresponding to an output voltage of the power converter, and the gate control signal corresponds to a discontinuous conduction mode (DCM) of the power converter. The gate control signal generation circuit transmits the gate control signal to a power switch of the power converter, and the power switch is turned on and turned off according to the gate control signal.

Another embodiment of the present invention provides an operation method of a controller applied to a power converter, wherein the controller includes a control signal generation circuit and a gate control signal generation circuit. The operation method includes the control signal generation circuit generating a control signal when an input voltage inputted to the power converter is greater than a predetermined voltage; and the gate control signal generation circuit generating a gate control signal corresponding to a continuous conduction mode of the power converter to a power switch of the power converter when the gate control signal generation circuit receives the control signal, wherein the power switch is turned on and turned off according to the gate control signal.

Another embodiment of the present invention provides an operation method of a controller applied to a power converter, wherein the controller includes a control signal generation circuit, a ramp voltage generation circuit, and a gate control signal generation circuit. The operation method includes the control signal generation circuit generating a control signal when an input voltage inputted to the power converter is greater than a predetermined voltage; the ramp voltage generation circuit utilizing a fixed current, a variable current, and a capacitor to generate a ramp voltage when the ramp voltage generation circuit receives the control signal, and the ramp voltage generation circuit utilizing the fixed current and the capacitor to generate the ramp voltage when the ramp voltage generation circuit does not receive the control signal; and the gate control signal generation circuit determining a turning-on time of a gate control signal according to the ramp voltage and a compensation voltage corresponding to an output voltage of the power converter, wherein the gate control signal corresponds to a discontinuous conduction mode of the power converter, wherein the gate control signal generation circuit transmits the gate control signal to a power switch of the power converter, and the power switch is turned on and turned off according to the gate control signal.

The present invention provides a controller applied to a power converter and an operation method thereof. The controller and the operation method utilize a control signal generation circuit to detect a turning-on time of a gate control signal according to a current flowing through a first inductor and a power switch of the power converter and to generate a control signal when the turning-on time of the gate control signal is greater than a predetermined time, and utilize a gate control signal generation circuit to generate the gate control signal corresponding to a continuous conduction mode according to the control signal, a ramp voltage corresponding to the control signal, and a compensation voltage. In addition, because the controller and the operation method utilize the turning-on time of the gate control signal to detect an input voltage to determine whether to switch an operation mode (e.g. a discontinuous conduction mode and the continuous conduction mode) of the power converter, the controller cannot have a pin further for detecting the input voltage. In addition, compared to the prior art, advantages of the present invention are shown as follows: first, because the current flowing through the first inductor and the power switch of the power converter is reduced, magnetic flux density of the first inductor is reduced, resulting in magnetic utilization efficiency of the first inductor being increased; second, because the magnetic utilization efficiency of the first inductor is increased, efficiency of power factor correction of the power converter is increased; third, because the current flowing through the first inductor and the power switch of the power converter is reduced, output power of the power converter is slightly increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller applied to a power converter according to a first embodiment of the present invention.

FIG. 2 is a diagram illustrating the peak and the valley of the input voltage.

FIG. 3 is a diagram illustrating the gate control signal generation circuit determining the turning-on time of the gate control signal according to the ramp voltage and the compensation voltage.

FIG. 4 is a diagram illustrating the turning-on time of the gate control signal corresponding to the continuous conduction mode being less than the turning-on time of the gate control signal corresponding to the discontinuous conduction mode.

FIG. 5 is a diagram illustrating the gate control signal generation circuit enabling the gate control signal corresponding to the discontinuous conduction mode again according to the zero-cross signal when the gate control signal generation circuit receives the zero-cross signal.

FIG. 6 is a diagram illustrating a controller applied to the power converter according to a second embodiment of the present invention.

FIG. 7 is a diagram illustrating a controller applied to the power converter according to a third embodiment of the present invention.

FIG. 8 is a flowchart illustrating an operation method of a controller applied to a power converter according to a fourth embodiment.

FIG. 9 is a flowchart illustrating an operation method of a controller applied to a power converter according to a fifth embodiment.

FIG. 10 is a flowchart illustrating an operation method of a controller applied to a power converter according to a sixth embodiment.

### DETAILED DESCRIPTION

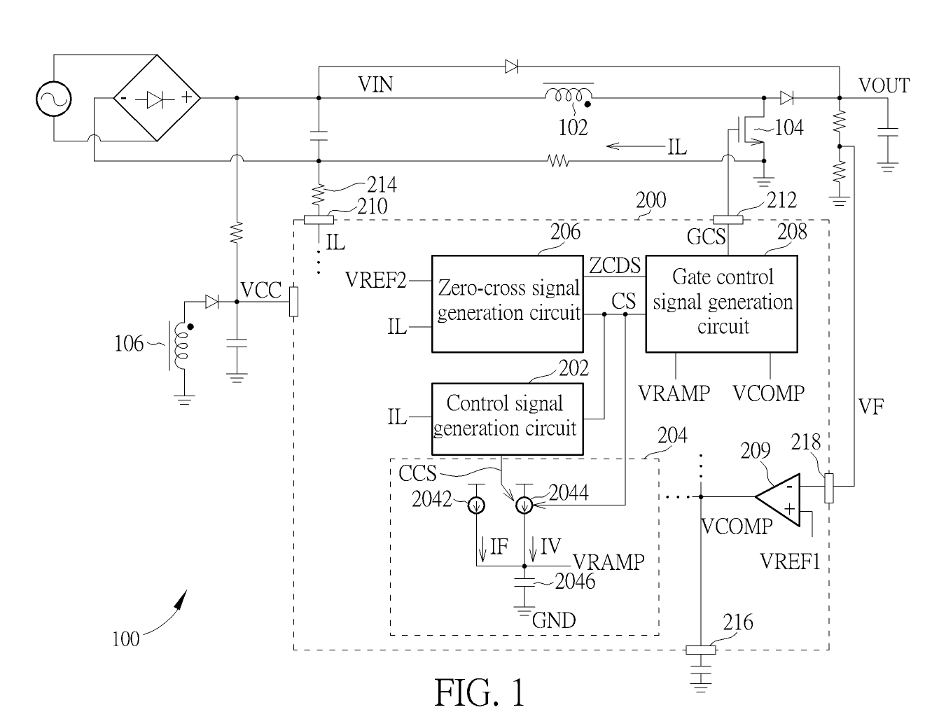

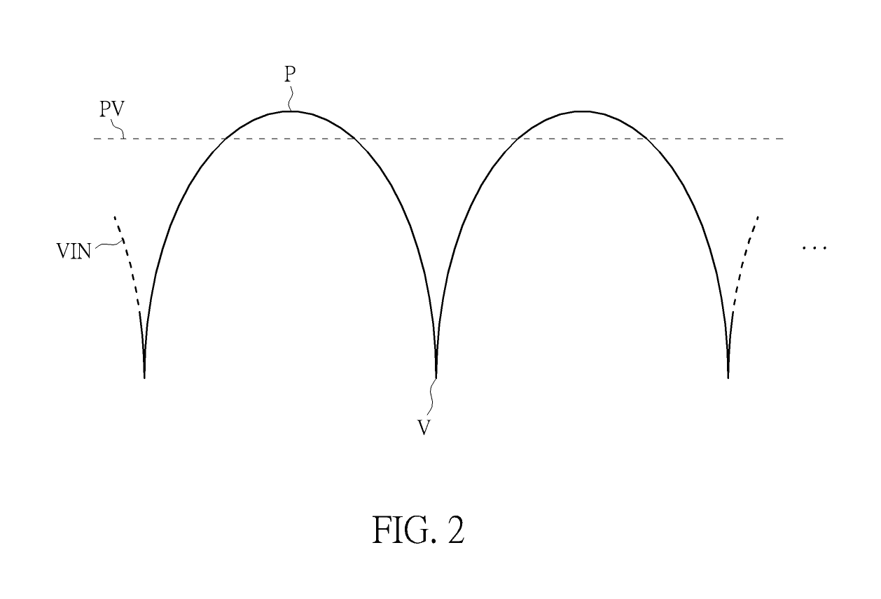

Please refer to FIG. 1. FIG. 1 is a diagram illustrating a controller 200 applied to a power converter 100 according to a first embodiment of the present invention, wherein the controller 200 includes a control signal generation circuit 202, a ramp voltage generation circuit 204, a zero-cross signal generation circuit 206, and a gate control signal generation circuit 208, and the control signal generation circuit 202 is coupled to the ramp voltage generation circuit 204, the zero-cross signal generation circuit 206, and the gate control signal generation circuit 208, the ramp voltage generation circuit 204 is further coupled to the gate control signal generation circuit 208, and the zero-cross signal generation circuit 206 is further coupled to the gate control signal generation circuit 208. In addition, the power converter 100 is a power factor correction (PFC) boost power converter. As shown in FIG. 1, the control signal generation circuit 202 can receive a current IL flowing through a first inductor 102 and a power switch 104 of the power converter 100 through a current detection pin 210 of the controller 200, and detect a turning-on time of a gate control signal GCS generated by the gate control signal generation circuit 208 according to a voltage of a capacitor (not shown in FIG. 1) of the control signal generation circuit 202, wherein the current IL charges the capacitor of the control signal generation circuit 202 to generate the voltage, and the turning-on time of the gate control signal GCS positively corresponds to the current IL. As shown in FIG. 2, the current IL corresponding to a peak P of the input voltage VIN is greater than the current IL corresponding to a valley V of the input voltage VIN. In addition, an operation principle of the control signal generation circuit 202 detecting the turning-on time of the gate control signal GCS through the current IL is obvious to one of ordinary skill in the art, so further description thereof is omitted for simplicity. In addition, because the turning-on time of the gate control signal GCS positively corresponds to the current IL, the turning-on time of the gate control signal GCS also positively corresponds to the input voltage VIN of the power converter 100. That is to say, as shown in FIG. 2, the turning-on time of the gate control signal GCS corresponding to the peak P of the input voltage VIN is greater than the turning-on time of the gate control signal GCS corresponding to the valley V of the input voltage VIN.

The control signal generation circuit 202 generates a control signal CS to the gate control signal generation circuit 208 when the turning-on time of the gate control signal GCS is greater than a predetermined time (that is, the input voltage VIN is greater than a predetermined voltage PV (as shown in FIG. 2)). But, the present invention is not limited to the control signal generation circuit 202 utilizing the turning-on time of the gate control signal GCS to detect the input voltage VIN to generate the control signal CS. That is to say, any configuration in which the control signal generation circuit 202 utilizes another pin of the controller 200 to detect the input voltage VIN to generate the control signal CS falls within the scope of the present invention. When the gate control signal generation circuit 208 receives the control signal CS, the gate control signal generation circuit 208 can be switched from generating the gate control signal GCS corresponding to a discontinuous conduction mode (DCM) of the power converter 100 to the power switch 104 of the power converter 100 to generating the gate control signal GCS corresponding to a continuous conduction mode (CCM) of the power converter 100 to the power switch 104 of the power converter 100. Meanwhile, a frequency of the gate control signal GCS corresponding to the continuous conduction mode is equal to the frequency of the gate control signal GCS corresponding to the discontinuous conduction mode before the gate control signal generation circuit 208 is going to generate the gate control signal GCS corresponding to the continuous conduction mode. In addition, when the gate control signal generation circuit 208 does not receive the control signal CS, the gate control signal generation circuit 208 generates the gate control signal GCS corresponding to the discontinuous conduction mode to the power switch 104 of the power converter 100.

As shown in FIG. 1, the ramp voltage generation circuit 204 includes a first current source 2042, a second current source 2044, and a capacitor 2046, wherein the second current source 2044 is turned on according to the control signal CS generated by the control signal generation circuit 202, the gate control signal GCS is transmitted to the power switch 104 through a gate pin 212 of the controller 200, the power switch 104 is turned on and turned off according to the gate control signal GCS, and the capacitor 2046 is coupled between the first current source 2042 and ground GND. As shown in FIG. 1, when the ramp voltage generation circuit 204 receives the control signal CS, a ramp voltage VRAMP generated by the ramp voltage generation circuit 204 is determined by a fixed current IF provided by the first current source 2042, a variable current IV provided by the second current source 2044, and the capacitor 2046 (that is, when the ramp voltage generation circuit 204 receives the control signal CS, the fixed current IF and the variable current IV charge the capacitor 2046 to generate the ramp voltage VRAMP), and when the ramp voltage generation circuit 204 does not receive the control signal CS, the ramp voltage VRAMP is determined by the fixed current IF and the capacitor 2046 (that is, when the ramp voltage generation circuit 204 does not receive the control signal CS, the fixed current IF charges the capacitor 2046 to generate the ramp voltage VRAMP). In addition, in one embodiment of the present invention, the control signal generation circuit 202 can further utilize a passive component 214 coupled to the current detection pin 210 to generate a current control signal CCS to control the variable current IV according to the current IL. That is to say, the control signal generation circuit 202 can increase the variable current IV according to increase of the current IL, and vice versa. But, the present invention is not limited to the passive component 214 being coupled to the current detection pin 210. In addition, in another embodiment of the present invention, the second current source 2044 provides another fixed current.

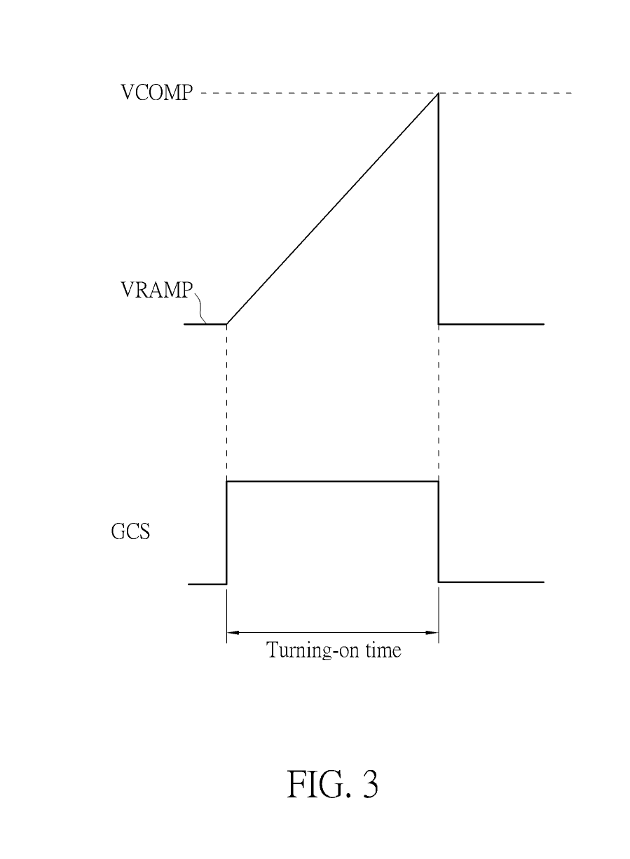

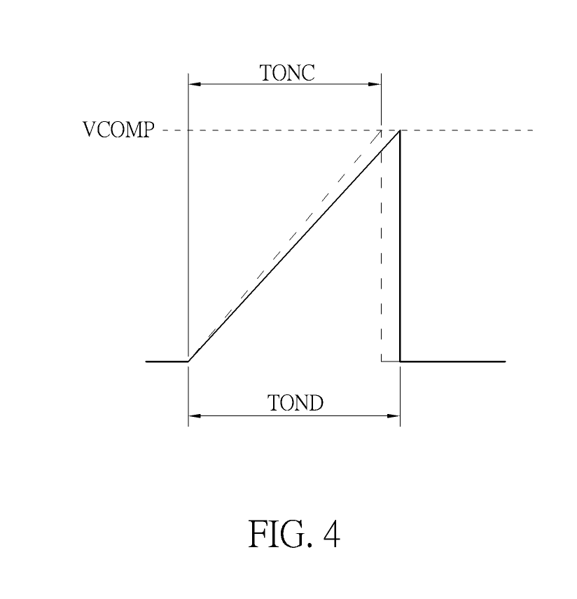

When the ramp voltage VRAMP is greater than a compensation voltage VCOMP of a compensation pin 216 of the controller 200, the gate control signal generation circuit 208 disables the gate control signal GCS. That is to say, the gate control signal generation circuit 208 can determine the turning-on time of the gate control signal GCS (as shown in FIG. 3) according to the ramp voltage VRAMP and the compensation voltage VCOMP, wherein a comparator 209 of the controller 200 can generate the compensation voltage VCOMP according to a feedback voltage VF of a feedback pin 218 of the controller 200 and a first reference voltage VREF1, and as shown in FIG. 1, because the feedback voltage VF is a divided voltage of an output voltage VOUT of the power converter 100, the compensation voltage VCOMP corresponds to the output voltage VOUT of the power converter 100. Because the gate control signal generation circuit 208 determines the turning-on time of the gate control signal GCS according to the ramp voltage VRAMP and the compensation voltage VCOMP, a slope of the ramp voltage VRAMP corresponding to the continuous conduction mode is greater than the slope of the ramp voltage VRAMP corresponding to the discontinuous conduction mode. That is to say, the turning-on time TONC of the gate control signal GCS corresponding to the continuous conduction mode is less than the turning-on time TOND of the gate control signal GCS (as shown in FIG. 4) corresponding to the discontinuous conduction mode.

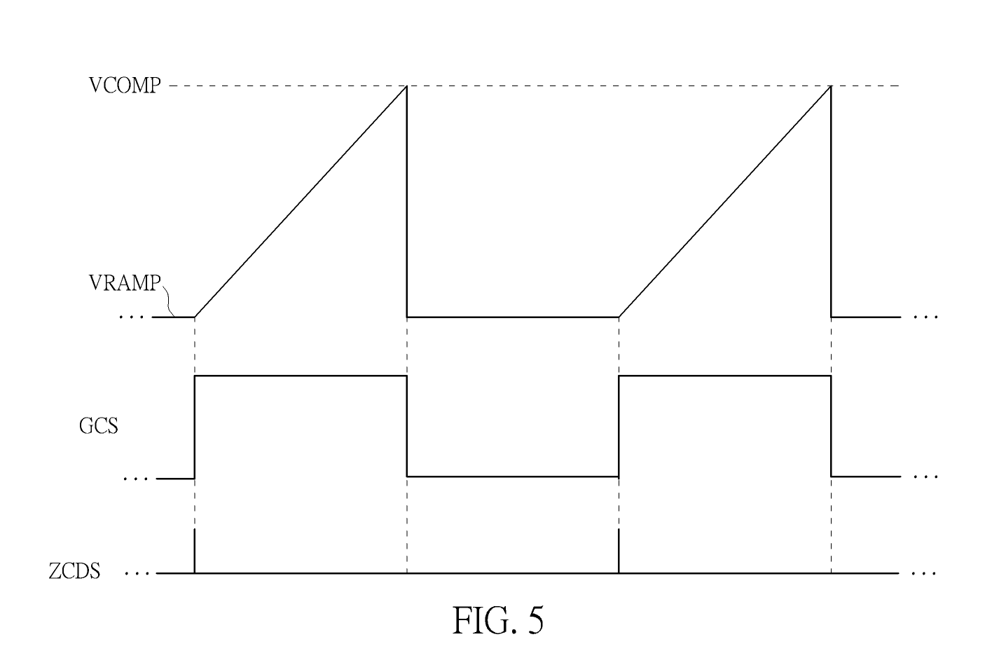

In addition, as shown in FIG. 1, the zero-cross signal generation circuit 206 can generate a zero-cross signal ZCDS according to a voltage corresponding to the current IL and a second reference voltage VREF2. When the control signal generation circuit 202 does not generate the control signal CS, the ramp voltage generation circuit 204 generates the ramp voltage VRAMP corresponding to the discontinuous conduction mode according to the fixed current IF and the capacitor 2046, so the gate control signal generation circuit 208 can determine the turning-on time TOND of the gate control signal GCS corresponding to the discontinuous conduction mode according to the ramp voltage VRAMP corresponding to the discontinuous conduction mode and the compensation voltage VCOMP. In addition, when the gate control signal generation circuit 208 receives the zero-cross signal ZCDS, the gate control signal generation circuit 208 can enable the gate control signal GCS corresponding to the discontinuous conduction mode (as shown in FIG. 5) again according to the zero-cross signal ZCDS.

In addition, when the control signal generation circuit 202 generates the control signal CS, the ramp voltage generation circuit 204 generates the ramp voltage VRAMP corresponding to the continuous conduction mode according to the fixed current IF, the variable current IV, and the capacitor 2046, so the gate control signal generation circuit 208 can determine the turning-on time TONC of the gate control signal GCS corresponding to the continuous conduction mode according to the ramp voltage VRAMP corresponding to the continuous conduction mode and compensation voltage VCOMP. In addition, when the zero-cross signal generation circuit 206 receives the control signal CS, the zero-cross signal generation circuit 206 can be turned off accordingly. Therefore, the gate control signal generation circuit 208 enables the gate control signal GCS corresponding to the continuous conduction mode again after the gate control signal generation circuit 208 disables the gate control signal GCS corresponding to the continuous conduction mode for a time-out.

Because when the gate control signal generation circuit 208 receives the control signal CS, the gate control signal generation circuit 208 generates the gate control signal GCS corresponding to the continuous conduction mode, the current IL flowing through the first inductor 102 and the power switch 104 of the power converter 100 can be reduced when the power converter 100 enters the continuous conduction mode. In addition, as shown in FIG. 4, because the turning-on time TONC of the gate control signal GCS corresponding to the continuous conduction mode is less than the turning-on time TOND of the gate control signal GCS corresponding to the discontinuous conduction mode, the present invention can further reduce the current IL flowing through the first inductor 102 and the power switch 104 of the power converter 100 by reducing the turning-on time of the gate control signal GCS. Therefore, because when the input voltage VIN is greater than the predetermined voltage PV, the present invention can make the power converter 100 enter the continuous conduction mode from the discontinuous conduction mode and reduce the turning-on time of the gate control signal GCS to reduce the current IL, compared to the prior art, advantages of the present invention are shown as follows: first, because the current IL is reduced, magnetic flux density of the first inductor 102 is reduced, resulting in magnetic utilization efficiency of the first inductor 102 being increased; second, because the magnetic utilization efficiency of the first inductor 102 is increased, efficiency of power factor correction of the power converter 100 is increased; third, because the current IL is reduced, output power of the power converter 100 is slightly increased. In addition, because the control signal generation circuit 202 utilizes the turning-on time of the gate control signal GCS to detect the input voltage VIN to determine whether to make the power converter 100 enter the continuous conduction mode and reduce the turning-on time of the gate control signal GCS to reduce the current IL, the controller 200 cannot have a pin further for detecting the input voltage VIN.

In addition, as shown in FIG. 1, a supply voltage VCC generated by a second inductor 106 of the power converter 100 is used for providing to all function circuits of the controller 200.

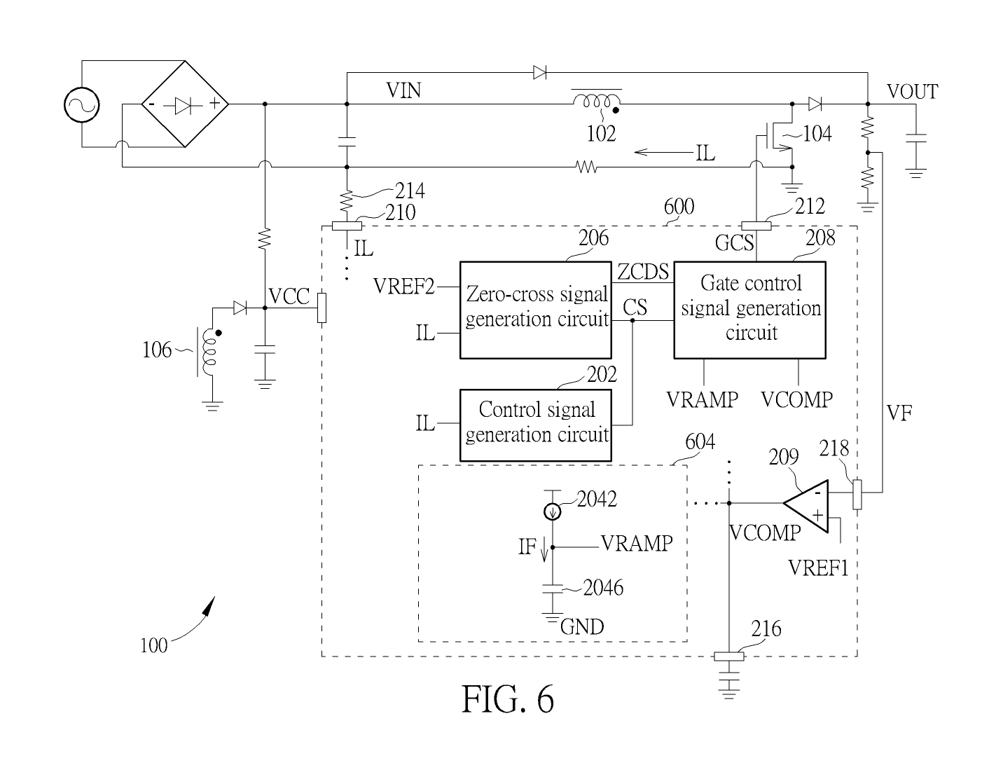

Please refer to FIG. 6. FIG. 6 is a diagram illustrating a controller 600 applied to the power converter 100 according to a second embodiment of the present invention. As shown in FIG. 6, a difference between the controller 600 and the controller 200 is that a ramp voltage generation circuit 604 of the controller 600 only includes the first current source 2042 and the capacitor 2046, so the ramp voltage generation circuit 604 only utilizes the fixed current IF provided by the first current source 2042 to charge the capacitor 2046 to generate the ramp voltage VRAMP (that is, the ramp voltage generation circuit 604 does not change the slope of the ramp voltage VRAMP). Therefore, when the control signal generation circuit 202 generates the control signal CS, the gate control signal generation circuit 208 can be switched from generating the gate control signal GCS corresponding to the discontinuous conduction mode to generating the gate control signal GCS corresponding to the continuous conduction mode according to the control signal CS, the ramp voltage VRAMP generated by the ramp voltage generation circuit 604, and the compensation voltage VCOMP. In addition, when the zero-cross signal generation circuit 206 receives the control signal CS, the zero-cross signal generation circuit 206 can be turned off accordingly, so the gate control signal generation circuit 208 enables the gate control signal GCS corresponding to the continuous conduction mode again after the gate control signal generation circuit 208 disables the gate control signal GCS corresponding to the continuous conduction mode for the time-out. In addition, subsequent operational principles of the controller 600 are the same as those of the controller 200, so further description thereof is omitted for simplicity.

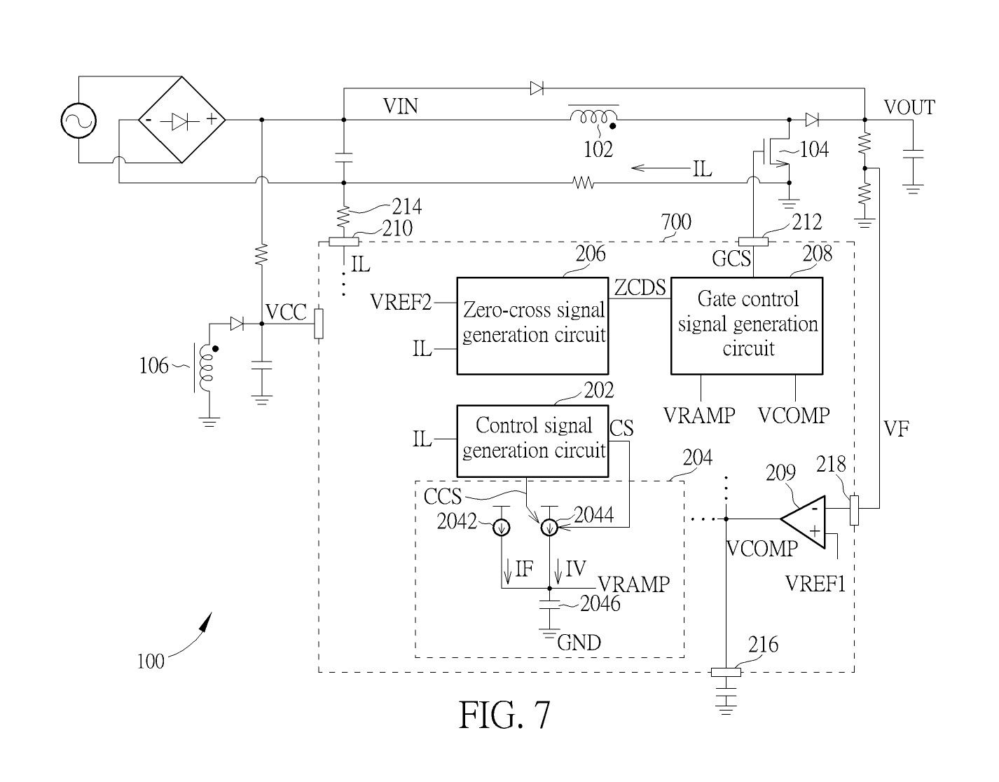

Please refer to FIG. 7. FIG. 7 is a diagram illustrating a controller 700 applied to the power converter 100 according to a third embodiment of the present invention. As shown in FIG. 7, a difference between the controller 700 and the controller 200 is that the zero-cross signal generation circuit 206 and the gate control signal generation circuit 208 of the controller 700 do not receive the control signal CS generated by the control signal generation circuit 202. That is to say, when the control signal generation circuit 202 generates the control signal CS, the zero-cross signal generation circuit 206 is not turned off, the gate control signal generation circuit 208 does not generate the gate control signal GCS corresponding to the continuous conduction mode, and the ramp voltage generation circuit 204 charges the capacitor 2046 to generate the ramp voltage VRAMP according to the control signal CS, the fixed current IF, and the variable current IV. Therefore, when the control signal generation circuit 202 generates the control signal CS, the gate control signal generation circuit 208 generates the gate control signal GCS corresponding to the discontinuous conduction mode according to the zero-cross signal ZCDS generated by the zero-cross signal generation circuit 206, the ramp voltage VRAMP generated by the ramp voltage generation circuit 204, and the compensation voltage VCOMP. In addition, subsequent operational principles of the controller 700 are the same as those of the controller 200, so further description thereof is omitted for simplicity.

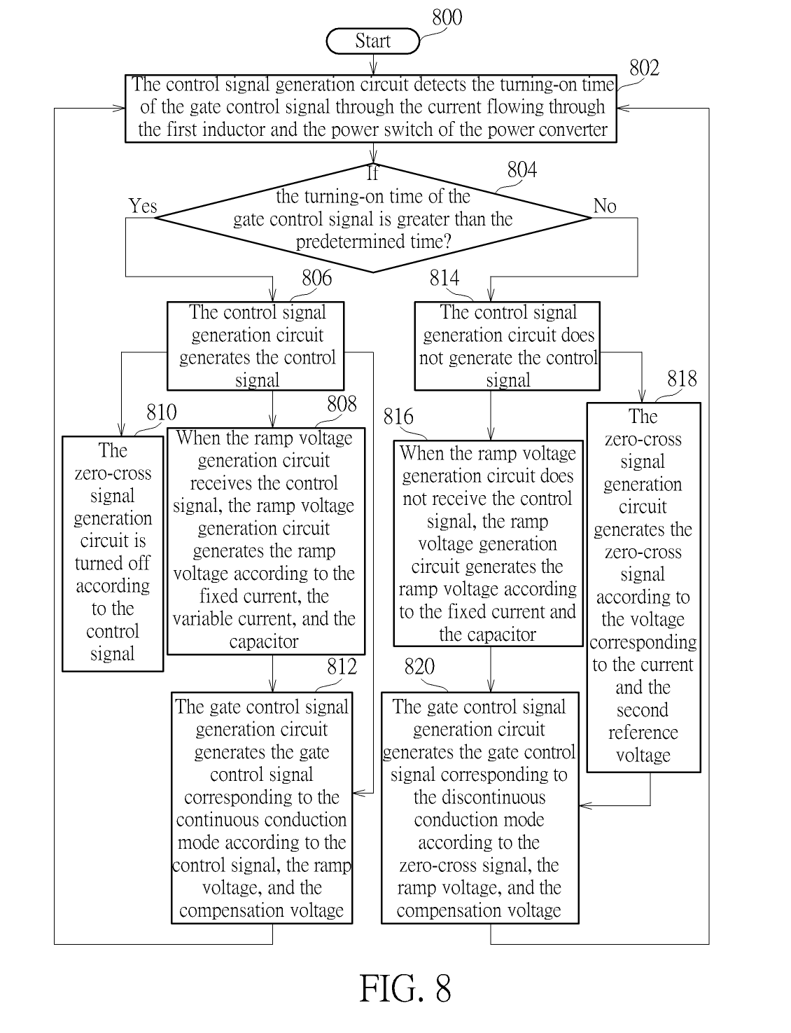

Please refer to FIGS. 1, 2, 4, 5, 8. FIG. 8 is a flowchart illustrating an operation method of a controller applied to a power converter according to a fourth embodiment. The operation method in FIG. 8 is illustrated using the power converter 100 and the controller 200 in FIG. 1. Detailed steps are as follows:

Step 800: Start.

Step 802: The control signal generation circuit 202 detects the turning-on time of the gate control signal GCS through the current IL flowing through the first inductor 102 and the power switch 104 of the power converter 100.

Step 804: If the turning-on time of the gate control signal GCS is greater than the predetermined time; if yes, go to Step 806; if no, go to Step 814.

Step 806: The control signal generation circuit 202 generates the control signal CS.

Step 808: When the ramp voltage generation circuit 204 receives the control signal CS, the ramp voltage generation circuit 204 generates the ramp voltage VRAMP according to the fixed current IF, the variable current IV, and the capacitor 2046.

Step 810: The zero-cross signal generation circuit 206 is turned off according to the control signal CS.

Step 812: The gate control signal generation circuit 208 generates the gate control signal GCS corresponding to the continuous conduction mode according to the control signal CS, the ramp voltage VRAMP, and the compensation voltage VCOMP, go to Step 802.

Step 814: The control signal generation circuit 202 does not generate the control signal CS.

Step 816: When the ramp voltage generation circuit 204 does not receive the control signal CS, the ramp voltage generation circuit 204 generates the ramp voltage VRAMP according to the fixed current IF and the capacitor 2046.

Step 818: The zero-cross signal generation circuit 206 generates the zero-cross signal ZCDS according to the voltage corresponding to the current IL and the second reference voltage VREF2.

Step 820: The gate control signal generation circuit 208 generates the gate control signal GCS corresponding to the discontinuous conduction mode according to the zero-cross signal ZCDS, the ramp voltage VRAMP, and the compensation voltage VCOMP, go to Step 802.

In Step 802, as shown in FIG. 1, the control signal generation circuit 202 can receive the current IL flowing through the first inductor 102 and the power switch 104 of the power converter 100 through the current detection pin 210, and detect the turning-on time of the gate control signal GCS generated by the gate control signal generation circuit 208 according to the voltage of the capacitor (not shown in FIG. 1) of the control signal generation circuit 202 charged by the current IL, wherein the turning-on time of the gate control signal GCS positively corresponds to the current IL. As shown in FIG. 2, the current IL corresponding to the peak P of the input voltage VIN is greater than the current IL corresponding to the valley V of the input voltage VIN. In addition, because the turning-on time of the gate control signal GCS positively corresponds to the current IL, the turning-on time of the gate control signal GCS also positively corresponds to the input voltage VIN of the power converter 100. That is to say, as shown in FIG. 2, the turning-on time of the gate control signal GCS corresponding to the peak P of the input voltage VIN is greater than the turning-on time of the gate control signal GCS corresponding to the valley V of the input voltage VIN.

In Step 806, when the turning-on time of the gate control signal GCS is greater than the predetermined time (that is, the input voltage VIN is greater than the predetermined voltage PV (as shown in FIG. 2)), the control signal generation circuit 202 generates the control signal CS to the gate control signal generation circuit 208.

In Step 808, as shown in FIG. 1, when the ramp voltage generation circuit 204 receives the control signal CS, the ramp voltage VRAMP generated by the ramp voltage generation circuit 204 is determined by the fixed current IF provided by the first current source 2042, the variable current IV provided by the second current source 2044, and the capacitor 2046 (that is, when the ramp voltage generation circuit 204 receives the control signal CS, the fixed current IF and the variable current IV charge the capacitor 2046 to generate the ramp voltage VRAMP). In addition, in one embodiment of the present invention, the control signal generation circuit 202 can further utilize the passive component 214 to generate the current control signal CCS to control the variable current IV according to the current IL. That is to say, the control signal generation circuit 202 can increase the variable current IV according to the current IL, and vice versa. But, in another embodiment of the present invention, the second current source 2044 provides another fixed current. In Step 810, when the zero-cross signal generation circuit 206 receives the control signal CS, the zero-cross signal generation circuit 206 can be turned off accordingly.

In Step 812, when the control signal generation circuit 202 generates the control signal CS, because the ramp voltage generation circuit 204 generates the ramp voltage VRAMP corresponding to the continuous conduction mode according to the fixed current IF, the variable current IV, and the capacitor 2046, the gate control signal generation circuit 208 can determine the turning-on time TONC of the gate control signal GCS corresponding to the continuous conduction mode (as shown in FIG. 4) according to the ramp voltage VRAMP corresponding to the continuous conduction mode and the compensation voltage VCOMP. In addition, because when the zero-cross signal generation circuit 206 receives the control signal CS, the zero-cross signal generation circuit 206 can be turned off accordingly, the gate control signal generation circuit 208 enables the gate control signal GCS corresponding to the continuous conduction mode again after the gate control signal generation circuit 208 disables the gate control signal GCS corresponding to the continuous conduction mode for the time-out.

In Step 816, when the ramp voltage generation circuit 204 does not receive the control signal CS, the ramp voltage VRAMP is determined by the fixed current IF and the capacitor 2046 (that is, when the ramp voltage generation circuit 204 does not receive the control signal CS, the fixed current IF charges the capacitor 2046 to generate the ramp voltage VRAMP). In Step 820, when the control signal generation circuit 202 does not generate the control signal CS, the ramp voltage generation circuit 204 generates the ramp voltage VRAMP corresponding to the discontinuous conduction mode according to the fixed current IF and the capacitor 2046, so the gate control signal generation circuit 208 can determine the turning-on time TOND of the gate control signal GCS corresponding to the discontinuous conduction mode (as shown in FIG. 4) according to the ramp voltage VRAMP corresponding to the discontinuous conduction mode and the compensation voltage VCOMP. In addition, when the gate control signal generation circuit 208 receives the zero-cross signal ZCDS, the gate control signal generation circuit 208 can enable the gate control signal GCS corresponding to the discontinuous conduction mode (as shown in FIG. 5) again according to the zero-cross signal ZCDS.

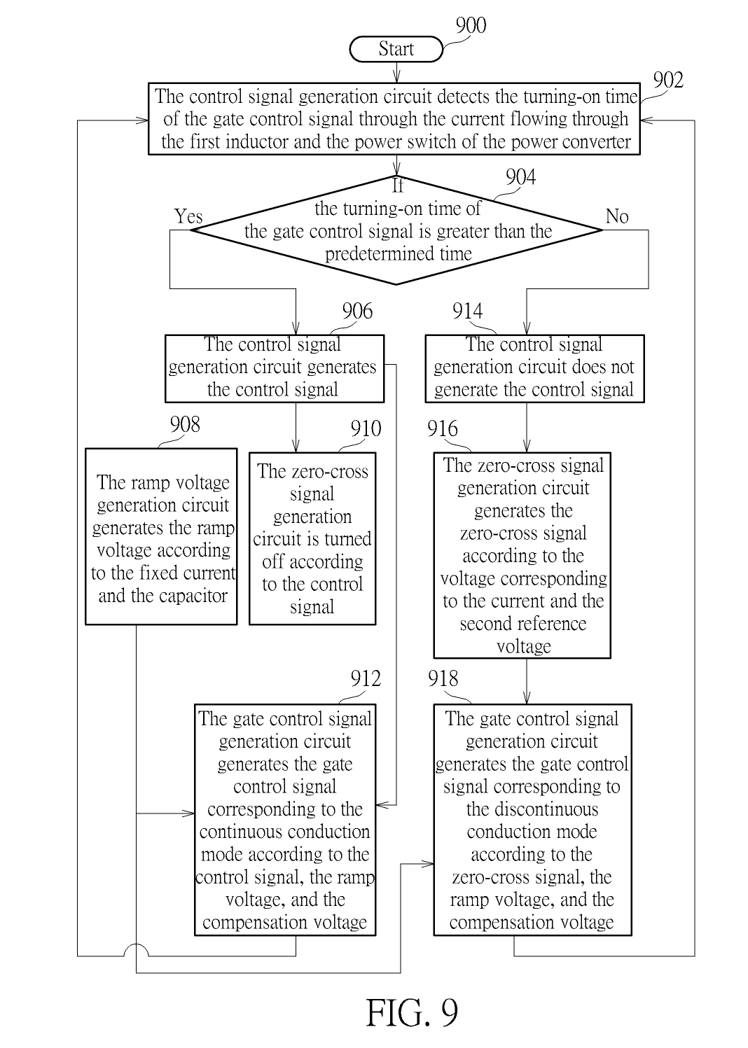

Please refer to FIGS. 6, 9. FIG. 9 is a flowchart illustrating an operation method of a controller applied to a power converter according to a fifth embodiment. The operation method in FIG. 9 is illustrated using the power converter 100 and the controller 600 in FIG. 6. Detailed steps are as follows:

Step 900: Start.

Step 902: The control signal generation circuit 202 detects the turning-on time of the gate control signal GCS through the current IL flowing through the first inductor 102 and the power switch 104 of the power converter 100.

Step 904: If the turning-on time of the gate control signal GCS is greater than the predetermined time; if yes, go to Step 906; if no, go to Step 914.

Step 906: The control signal generation circuit 202 generates the control signal CS.

Step 908: The ramp voltage generation circuit 204 generates the ramp voltage VRAMP according to the fixed current IF and the capacitor 2046, go to Step 912 and Step 918.

Step 910: The zero-cross signal generation circuit 206 is turned off according to the control signal CS.

Step 912: The gate control signal generation circuit 208 generates the gate control signal GCS corresponding to the continuous conduction mode according to the control signal CS, the ramp voltage VRAMP, and the compensation voltage VCOMP, go to Step 902.

Step 914: The control signal generation circuit 202 does not generate the control signal CS.

Step 916: The zero-cross signal generation circuit 206 generates the zero-cross signal ZCDS according to the voltage corresponding to the current IL and the second reference voltage VREF2.

Step 918: The gate control signal generation circuit 208 generates the gate control signal GCS corresponding to the discontinuous conduction mode according to the zero-cross signal ZCDS, the ramp voltage VRAMP, and the compensation voltage VCOMP, go to Step 902.

A difference between the embodiment in FIG. 9 and the embodiment in FIG. 8 is that in Step 908, as shown in FIG. 6, the ramp voltage generation circuit 604 only utilizes the fixed current IF provided by the first current source 2042 to charge the capacitor 2046 to generate the ramp voltage VRAMP (that is, the ramp voltage generation circuit 604 does not change the slope of the ramp voltage VRAMP). In addition, subsequent operational principles of the embodiment in FIG. 9 are the same as those of the embodiment in FIG. 8, so further description thereof is omitted for simplicity.

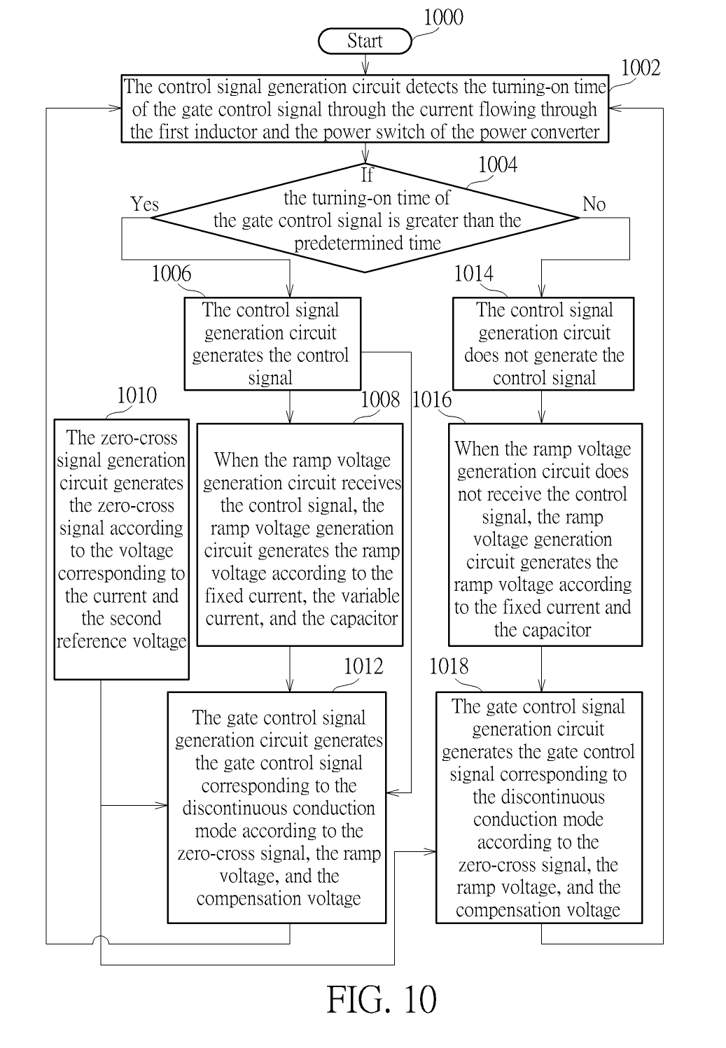

Please refer to FIG. 7, 10. FIG. 10 is a flowchart illustrating an operation method of a controller applied to a power converter according to a sixth embodiment. The operation method in FIG. 10 is illustrated using the power converter 100 and the controller 700 in FIG. 7. Detailed steps are as follows:

Step 1000: Start.

Step 1002: The control signal generation circuit 202 detects the turning-on time of the gate control signal GCS through the current IL flowing through the first inductor 102 and the power switch 104 of the power converter 100.

Step 1004: If the turning-on time of the gate control signal GCS is greater than the predetermined time; if yes, go to Step 1006; if no, go to Step 1014.

Step 1006: The control signal generation circuit 202 generates the control signal CS.

Step 1008: When the ramp voltage generation circuit 204 receives the control signal CS, the ramp voltage generation circuit 204 generates the ramp voltage VRAMP according to the fixed current IF, the variable current IV, and the capacitor 2046.

Step 1010: The zero-cross signal generation circuit 206 generates the zero-cross signal ZCDS according to the voltage corresponding to the current IL and the second reference voltage VREF2, go to Step 1012 and Step 1018.

Step 1012: The gate control signal generation circuit 208 generates the gate control signal GCS corresponding to the discontinuous conduction mode according to the zero-cross signal ZCDS, the ramp voltage VRAMP, and the compensation voltage VCOMP, go to Step 1002.

Step 1014: The control signal generation circuit 202 does not generate the control signal CS.

Step 1016: When the ramp voltage generation circuit 204 does not receive the control signal CS, the ramp voltage generation circuit 204 generates the ramp voltage VRAMP according to the fixed current IF and the capacitor 2046.

Step 1018: The gate control signal generation circuit 208 generates the gate control signal GCS corresponding to the discontinuous conduction mode according to the zero-cross signal ZCDS, the ramp voltage VRAMP, and the compensation voltage VCOMP, go to Step 1002.

Differences between the embodiment in FIG. 10 and the embodiment in FIG. 8 are that in Step 1010, as shown in FIG. 7, when the control signal generation circuit 202 generates the control signal CS, the zero-cross signal generation circuit 206 is not turned off, and in Step 1012 and Step 1018, the gate control signal generation circuit 208 always generates the gate control signal GCS corresponding to the discontinuous conduction mode according to the zero-cross signal ZCDS, the ramp voltage VRAMP, and the compensation voltage VCOMP. In addition, subsequent operational principles of the embodiment in FIG. 10 are the same as those of the embodiment in FIG. 8, so further description thereof is omitted for simplicity.

To sum up, the controller applied to the power converter and the operation method thereof utilize the control signal generation circuit to detect the turning-on time of the gate control signal according to the current flowing through the first inductor and the power switch of the power converter and to generate the control signal when the turning-on time of the gate control signal is greater than the predetermined time, and utilize the gate control signal generation circuit to generate the gate control signal corresponding to the continuous conduction mode according to the control signal, the ramp voltage corresponding to the control signal, and the compensation voltage. In addition, because the controller and the operation method utilize the turning-on time of the gate control signal to detect the input voltage to determine whether to switch an operation mode (e.g. the discontinuous conduction mode and the continuous conduction mode) of the power converter, the controller cannot have the pin further for detecting the input voltage. In addition, compared to the prior art, advantages of the present invention are shown as follows: first, because the current flowing through the first inductor and the power switch of the power converter is reduced, the magnetic flux density of the first inductor is reduced, resulting in the magnetic utilization efficiency of the first inductor being increased; second, because the magnetic utilization efficiency of the first inductor is increased, the efficiency of the power factor correction of the power converter is increased; third, because the current flowing through the first inductor and the power switch of the power converter is reduced, the output power of the power converter is slightly increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller applied to a power converter, comprising:
a control signal generation circuit for generating a control signal when an input voltage inputted to the power converter is greater than a predetermined voltage; and
a gate control signal generation circuit coupled to the control signal generation circuit, wherein when the gate control signal generation circuit receives the control signal, the gate control signal generation circuit generates a gate control signal corresponding to a continuous conduction mode (CCM) of the power converter to a power switch of the power converter, wherein the power switch is turned on and turned off according to the gate control signal.

2. The controller of claim 1, wherein the control signal generation circuit detects a turning-on time of the gate control signal, and when the turning-on time of the gate control signal is greater than a predetermined time, the control signal generation circuit generates the control signal, wherein the turning-on time of the gate control signal corresponds to the input voltage.

3. The controller of claim 2, further comprising:
a ramp voltage generation circuit coupled to the control signal generation circuit and the gate control signal generation circuit, wherein when the ramp voltage generation circuit receives the control signal, the ramp voltage generation circuit utilizes a fixed current, a variable current, and a capacitor to generate a ramp voltage to the gate control signal generation circuit, and when the ramp voltage generation circuit does not receive the control signal, the ramp voltage generation circuit utilizes the fixed current and the capacitor to generate the ramp voltage to the gate control signal generation circuit.

4. The controller of claim 3, wherein the gate control signal generation circuit determines the turning-on time of the gate control signal according to the ramp voltage and a compensation voltage corresponding to an output voltage of the power converter.

5. The controller of claim 3, wherein the variable current is controlled by a passive component outside the controller.

6. The controller of claim 1, wherein the power converter is a power factor correction (PFC) boost power converter.

7. A controller applied to a power converter, comprising:
a control signal generation circuit for generating a control signal when an input voltage inputted to the power converter is greater than a predetermined voltage;
a ramp voltage generation circuit coupled to the control signal generation circuit, wherein when the ramp voltage generation circuit receives the control signal, the ramp voltage generation circuit utilizes a fixed current, a variable current, and a capacitor to generate a ramp voltage, and when the ramp voltage generation circuit does not receive the control signal, the ramp voltage generation circuit utilizes the fixed current and the capacitor to generate the ramp voltage; and
a gate control signal generation circuit coupled to the ramp voltage generation circuit, wherein the gate control signal generation circuit determines a turning-on time of a gate control signal according to the ramp voltage and a compensation voltage corresponding to an output voltage of the power converter, and the gate control signal corresponds to a discontinuous conduction mode (DCM) of the power converter;
wherein the gate control signal generation circuit transmits the gate control signal to a power switch of the power converter, and the power switch is turned on and turned off according to the gate control signal.

8. The controller of claim 7, wherein the variable current is controlled by a passive component outside the controller.

9. The controller of claim 7, wherein the power converter is a power factor correction (PFC) boost power converter.

10. An operation method of a controller applied to a power converter, wherein the controller comprises a control signal generation circuit and a gate control signal generation circuit, the operation method comprising:
the control signal generation circuit generating a control signal when an input voltage inputted to the power converter is greater than a predetermined voltage; and
the gate control signal generation circuit generating a gate control signal corresponding to a continuous conduction mode of the power converter to a power switch of the power converter when the gate control signal generation circuit receives the control signal, wherein the power switch is turned on and turned off according to the gate control signal.

11. The operation method of claim 10, wherein the control signal generation circuit detects a turning-on time of the gate control signal, and when the turning-on time of the gate control signal is greater than a predetermined time, the control signal generates the control signal, wherein the turning-on time of the gate control signal corresponds to the input voltage.

12. The operation method of claim 11, further comprising:
a ramp voltage generation circuit utilizing a fixed current, a variable current, and a capacitor to generate a ramp voltage to the gate control signal generation circuit when the ramp voltage generation circuit receives the control signal, wherein the ramp voltage generation circuit is coupled to the control signal generation circuit and the gate control signal generation circuit; and
the ramp voltage generation circuit utilizing the fixed current and the capacitor to generate the ramp voltage to the gate control signal generation circuit when the ramp voltage generation circuit does not receive the control signal.

13. The operation method of claim 12, wherein the gate control signal generation circuit determines the turning-on time of the gate control signal according to the ramp voltage and a compensation voltage corresponding to an output voltage of the power converter.

14. The operation method of claim 12, wherein the variable current is controlled by a passive component outside the controller.

15. An operation method of a controller applied to a power converter, wherein the controller comprises a control signal generation circuit, a ramp voltage generation circuit, and a gate control signal generation circuit, the operation method comprising:
the control signal generation circuit generating a control signal when an input voltage inputted to the power converter is greater than a predetermined voltage;
the ramp voltage generation circuit utilizing a fixed current, a variable current, and a capacitor to generate a ramp voltage when the ramp voltage generation circuit receives the control signal, and the ramp voltage generation circuit utilizing the fixed current and the capacitor to generate the ramp voltage when the ramp voltage generation circuit does not receive the control signal; and
the gate control signal generation circuit determining a turning-on time of agate control signal according to the ramp voltage and a compensation voltage corresponding to an output voltage of the power converter, wherein the gate control signal corresponds to a discontinuous conduction mode of the power converter;
wherein the gate control signal generation circuit transmits the gate control signal to a power switch of the power converter, and the power switch is turned on and turned off according to the gate control signal.

16. The operation method of claim 15, wherein the variable current is controlled by a passive component outside the controller.
